(19) United States
(12) Patent Application Publication
(10) Pub. No.: US 2023/0292957 A1
(43) Pub. Date: Sep. 21, 2023

(54) AUTOMATED FOOD FRYING SYSTEM

(71) Applicant: Miso Robotics, Inc., Pasadena, CA (US)

(72) Inventors: Ryan R. Wach, Valencia, CA (US); Abhimanyu Bhakuni, Pasadena, CA (US); Philip Stahlhuth, Pasadena, CA (US); Dev Kumar, Pasadena, CA (US)

(21) Appl. No.: 18/103,697

(22) Filed: Jan. 31, 2023

Related U.S. Application Data
(60) Provisional application No. 63/306,411, filed on Feb. 3, 2022.

(51) Int. Cl. A47J 37/12; A47J 44/00; A47J 47/01; A47J 43/07; A47J 43/046; A23L 5/10; B25J 15/08; B25J 11/00

(52) U.S. Cl. CPC A47J 37/1228; A23L 5/11; A47J 37/1266; A47J 37/1276; A47J 37/1295; A47J 43/046; A47J 43/0722; A47J 43/0727; A47J 44/00; A47J 47/01; B25J 11/0045; B25J 15/08

(57) ABSTRACT

An automated food frying system includes a plurality of functional stations for dispensing a predetermined amount of raw food, transferring the raw food to a fry basket, frying the raw food, transferring the cooked food to a mixing bowl, mixing the cooked food with seasonings, transferring the cooked food to a receiving pan, and cleaning the mixing bowl. Related methods are described.

### CROSS-REFERENCE TO RELATED APPLICATIONS

This application claims priority to provisional application no. 63/306,411, filed Feb. 3, 2022, entitled “AUTOMATED FOOD FRYING SYSTEM”, incorporated herein by reference in its entirety for all purposes.

### BACKGROUND OF THE INVENTION

### 1. Field of the Invention

This invention relates to food frying systems, and more particularly, to automated food frying systems adapted to provide freshly fried and seasoned food items without human interaction.

### 2. Description of Related Art

In the restaurant environment, fried food items are prepared by restaurant employees using conventional fryers. The restaurant employee takes an order, manually adds the raw food items to the fry basket, lowers the fry basket into the fryer, cooks the food items, removes the fry basket from the fryer, dumps the cooked food items into a pan, adds seasoning to the food items, and manually mixes the food and seasonings together. The process relies heavily on employee labor, exposes the employee to dangerous hot oil, is prone to inconsistencies, and is not scalable for multiple orders.

There is therefore a need for improved fryer systems, and particularly, one that is fully automated.

### SUMMARY OF THE INVENTION

In embodiments of the invention, an automated food frying system for frying a food item includes a plurality of functional stations for dispensing, elevating, frying, and seasoning.

In embodiments of the invention, additional functional modules include a cooked food transferring module to transfer the cooked food item to hot storage as well as a cleaning module for wiping down and optionally spraying down the mixing bowl.

In embodiments of the invention, the automated food frying system includes a computer system and electronics programmed and operable to control the functional stations.

In embodiments of the invention, the automated food frying system includes a touchscreen display in communication with the computer system and is operable to, amongst other things, receive a customer order, display current orders in progress, and display an order queue.

In embodiments of the invention, the computer is programmed and operable store and update status of the food, wherein the status comprises at least one status from the groups comprising: on-line/ready, dispensing, frying, mixing, order ready/pickup, service, off-line.

In embodiments of the invention, a method for automatically frying food comprises the following steps: dispensing a predetermined amount of raw food into a basin; transferring the raw food from the basin to a fry basket; frying the raw food, defining cooked food; robotically transferring the cooked food from the fry basket to a mixing bowl; and dispensing at least one seasoning into the bowl; mixing the cooked food with the at least one type of seasoning, defining mixed food; and dumping the mixed food into a receiving pan; and wherein each of the steps is controlled by a computer system.

In embodiments of the invention, transferring the raw food comprises elevating the raw food to a target elevation above the fry basket, and rotating a freely pivotable basin until the raw food is dumped from the freely pivotable basin into the fry basket.

In embodiments of the invention, the method further comprises weighing the raw food prior to dumping the raw food into the fry basket.

In embodiments of the invention, the method further comprises passively agitating the raw food during the frying step, and optionally, the agitating comprises vortexing the raw food and oil within the fry basket during frying. In embodiments of the invention, the vortexing is performed by providing a plurality of symmetrically arranged vents in a bottom plate of the fry basket.

In embodiments of the invention, the dumping step is performed by tilting the mixing bowl to first angle.

In embodiments of the invention, the method further comprises draining the mixing bowl subsequent to the dumping step, wherein the draining step is performed by tilting the mixing bowl to a second angle in an opposite direction from the first angle such that the debris falls from the mixing bowl.

In embodiments of the invention, the method further comprises spraying the mixing bowl to rinse the mixing bowl, wherein the titling and spraying is controlled by the computer system.

In embodiments of the invention, an elevator unit is operable for lifting and dumping raw food into a fry basket as described herein.

In embodiments of the invention, a mixing bowl assembly is operable to mix the cooked food with ingredients, and to controllably dump the mixed food into a receiving pan and dump the debris into a waste container as described herein.

In embodiments of the invention, a fry basket comprises a bottom plate and a plurality of the elongate vents radially extending along the bottom plate from the center of the bottom plate. In embodiments of the invention, the vents are arranged in a symmetric pattern. In embodiments of the invention, the vents are arranged to direct the oil and food in a spiral motion, facilitating the agitation and prohibiting clumping during cooking.

In embodiments of the invention, a non-transitory storage medium, having a set of computer-readable instructions stored thereon for dispensing a predetermined amount of food, transferring the food to a fry basket, frying the food, transferring the food to a mixing bowl, mixing the cooked food with seasonings, transferring the seasoned food to a receiving pan, and optionally, cleaning the bowl as described herein.

The description, objects and advantages of the present invention will become apparent from the detailed description to follow, together with the accompanying drawings.

### BRIEF DESCRIPTION OF THE DRAWINGS

FIG. 1 illustrates a right-side top isometric view of an automated food frying system in accordance with an embodiment of the invention;

FIG. 2 is a flow chart of a method for frying food in accordance with an embodiment of the invention

FIG. 3 illustrates an automated food frying system dispensing chips from a hopper into an elevator basin in accordance with embodiments of the invention;

FIGS. 4A-6 are various views showing the cooperation between the elevator basin and scale for weighing the contents in the basin in accordance with embodiments of the invention;

FIGS. 7-8 are various views transferring the contents from the basin into a fry basket in accordance with embodiments of the invention;

FIGS. 9-10 are front perspective views of the automated fryer station depicting lowering the fry basket into the fryer in accordance with an embodiment of the invention;

FIG. 11 is a perspective view of a novel fry basket in accordance with another embodiment of the invention;

FIG. 12 is a front perspective view of the automated fryer station depicting draining and drying the cooked food items in accordance with an embodiment of the invention;

FIG. 13 is a front perspective view of the automated fryer station depicting transferring the cooked food items from the fry basket to the mixing bowl in accordance with an embodiment of the invention;

FIG. 14 is a front perspective view of the automated fryer station depicting dispensing seasonings into the mixing bowl in accordance with an embodiment of the invention;

FIG. 15 is a front perspective view of the automated fryer station depicting mixing the seasonings with the cooked food items in accordance with an embodiment of the invention;

FIG. 16 is a front perspective view of the automated fryer station depicting transferring the seasoned cooked food items from the mixing bowl to the storage pan in accordance with an embodiment of the invention;

FIG. 17 is a front perspective view of the automated fryer station depicting tilting the mixing bowl assembly rearwardly for cleaning in accordance with an embodiment of the invention;

FIGS. 18-19 are front and rear views, respectively, of the automated fryer station depicting draining and cleaning the mixing bowl in accordance with an embodiment of the invention;

FIG. 20 is a block diagram of an automated food frying system in accordance with an embodiment of the invention;

FIG. 21 is an enlarged front right side perspective view of a bowl assembly in accordance with an embodiment of the invention;

FIG. 22 is a cross section of the bowl assembly shown in FIG. 21 taken along line 22-22;

FIG. 23 is bottom view of the blade shown in FIG. 21;

FIGS. 24-25 are bottom perspective and upper perspective views of the bowl shown in FIG. 21, respectively;

FIG. 26 is a side perspective view of an end effector assembly for gripping a basket handle in accordance with an embodiment of the invention;

FIG. 27 is an exploded view of the end effector assembly shown in FIG. 26 shown in an unlocked configuration in accordance with an embodiment of the invention;

FIG. 28 is an enlarged side perspective view of the end effector assembly shown in FG. 26 shown in a locked configuration in accordance with an embodiment of the invention; and

FIG. 29 is a cross sectional view of the end effector assembly shown in FIG. 28 in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

### Apparatus Overview

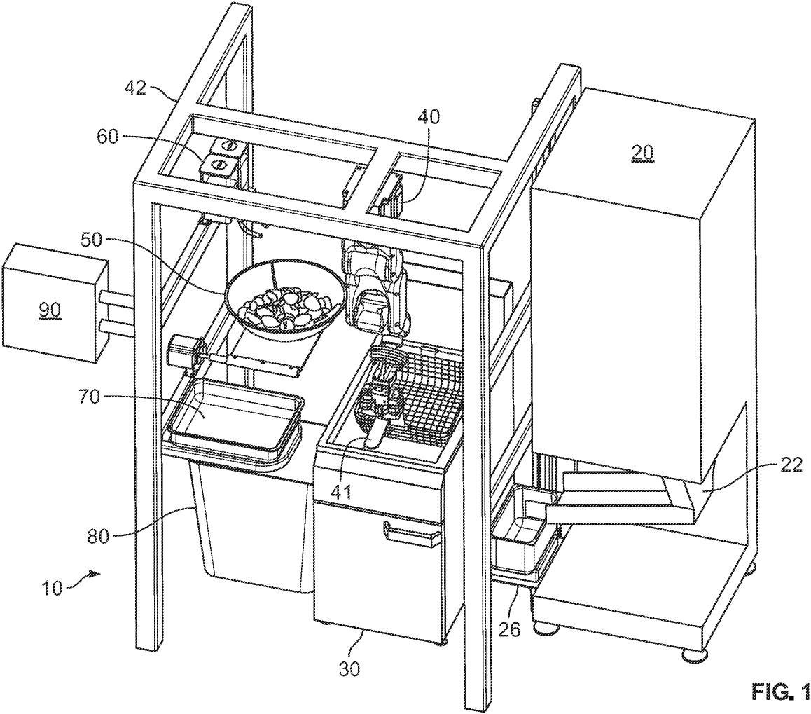

FIG. 1 shows an automated food frying system 10 in accordance with an embodiment of the invention. The system 10 shown in FIG. 1 includes a refrigerated food dispenser/hopper 20 for storing and dispensing a plurality of raw food items along ramp 22 into elevator basin 26. An example of a suitable refrigerated food dispenser is the RAM 280, manufactured by Taylor UK (Ipswich, England). Non-limiting examples of types of raw foods include tortilla chips, fries, popcorn chicken, chicken nuggets or wings, fish sticks, and vegetables.

Various functional stations or modules are arranged on a frame 42 to cook or otherwise prepare the food as described herein. In the embodiment shown in FIG. 1, the automated fryer system includes a fryer 30, fry basket 41, robotic arm 40, mixing bowl 50, season dispensers 60, storage pan 70, and drain capture 80.

Additional electronic, computer and display components, discussed herein, can be enclosed within a housing or enclosure 90 and mounted to the frame for controlling the various stations and collecting and storing data.

Additionally, although the system 10 is shown with robotic arm 40 mounted on a frame 42, in other embodiments, the robotic arm can be arranged as a stand-alone unit adjacent the fryer.

Additionally, the invention is not limited to one fryer. Embodiments of the invention may arrange multiple fryers together for cooking food items in parallel. Likewise, multiple mixing bowls and storage pans may be arranged to receive the cooked food items. Multiple elevator units can be arranged to receive batches of frozen food from dedicated ramps. Thus, although FIG. 1 is illustrative of one embodiment of an automated fry system it is to be understood the functional modules may be arranged differently than that shown, and in particular, additional functional units may be added to the system to increase throughput as desired.

### Method Overview

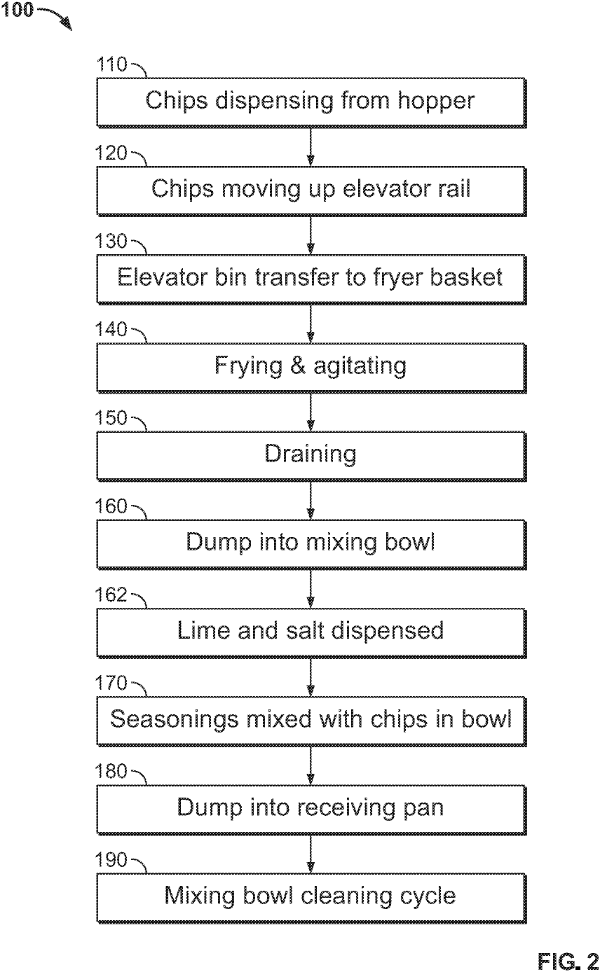

FIG. 2 shows a flow chart of a method 100 of frying chips in accordance with an embodiment of the invention.

Step 110 states to dispense chips from the hopper. This step may be performed as shown in FIG. 3 in which the cold or raw chips 21 are gravity fed along ramp 22 and into elevator basin 26. As stated, above, an example of a suitable refrigerated food hopper/dispenser is the RAM 280, manufactured by Taylor UK (Ipswich, England).

### Weigh Food

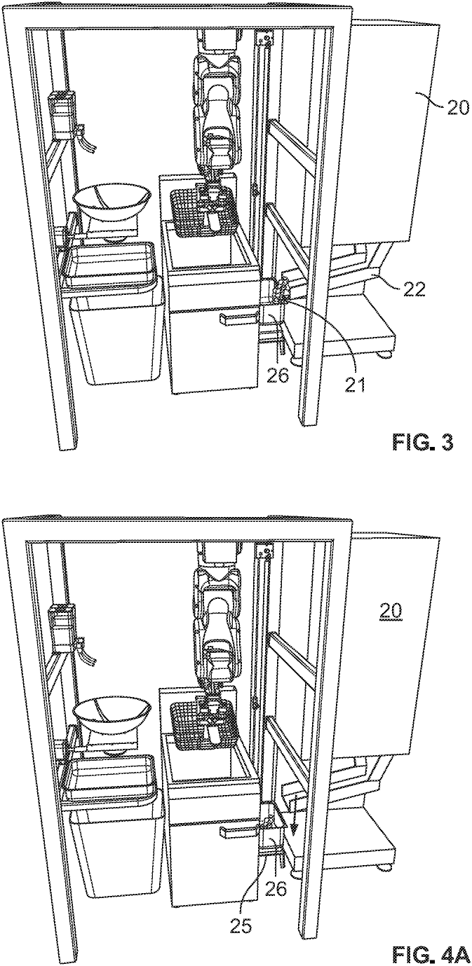

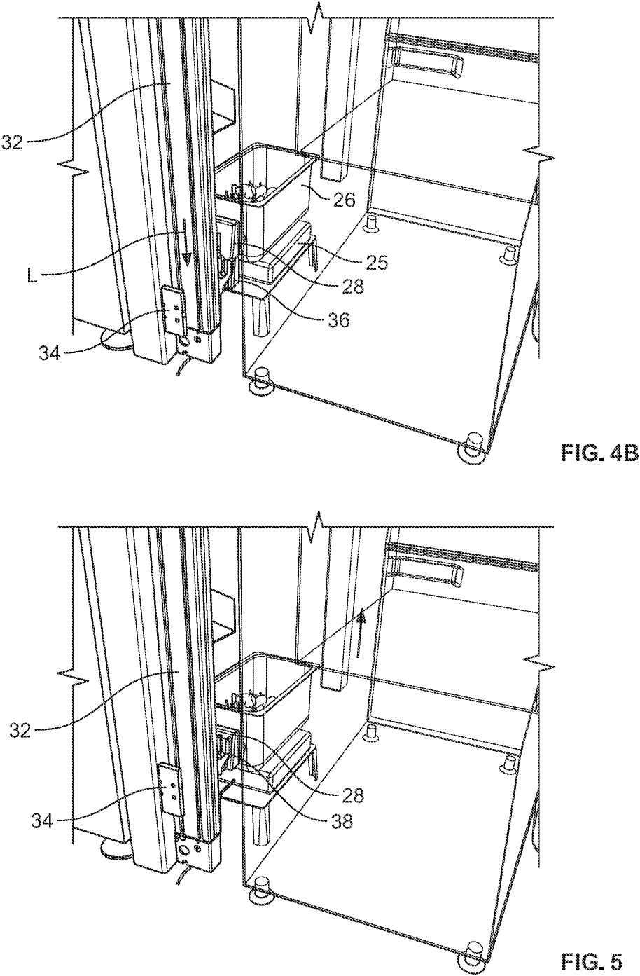

Optionally, and with reference to FIGS. 4A-4B, the basin 26 of chips is lowered onto scale 25 for weighing and determining if a sufficient quantity was dispensed from the hopper 20. As the carriage 34 is lowered (L), basin 26 contacts the scale 25 at which point the carriage 34 and basin connector 36 continue to lower (detaching from basin hold 28) while the basin 26 remains (and floats freely) on the scale. The scale may be an off-the-shelf type unit or optionally, the scale may be constructed by incorporating a sensor such as a load cell underneath a platform which engages the elevator basin 26 as the basin is lowered.

Next, a determination is made whether the amount of food in the basin is sufficient based on computing the difference between predetermined recipe data and the measured amount in the basin. This step may be performed by the computer.

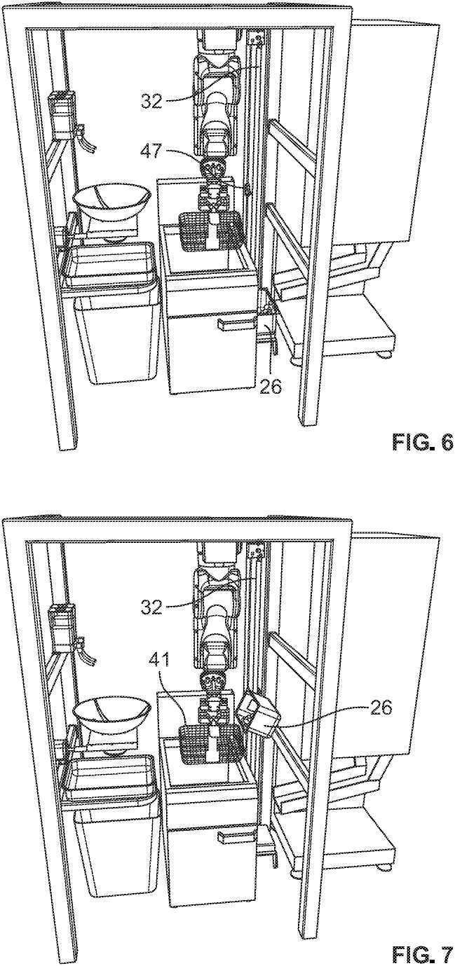

With reference to FIGS. 4B-6, the carriage 34 and basin connector 36 are then elevated until the basin connector 36 engages the basin hold 28. The carriage 34 is further elevated and the basin 26 consequently rises from the scale 25. The basin 26 is then positioned either (1) at a home position to receive more raw food or, if the amount of food in the basin was determined to be sufficient, (2) to continue to the next step in the food frying process 130, namely, to transfer the chips to the fry basket.

### Elevator Basin Transfer

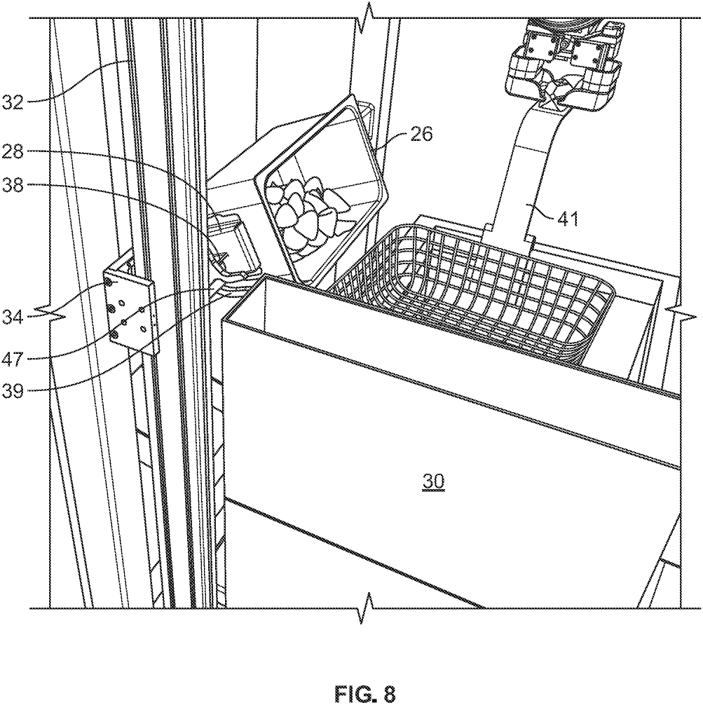

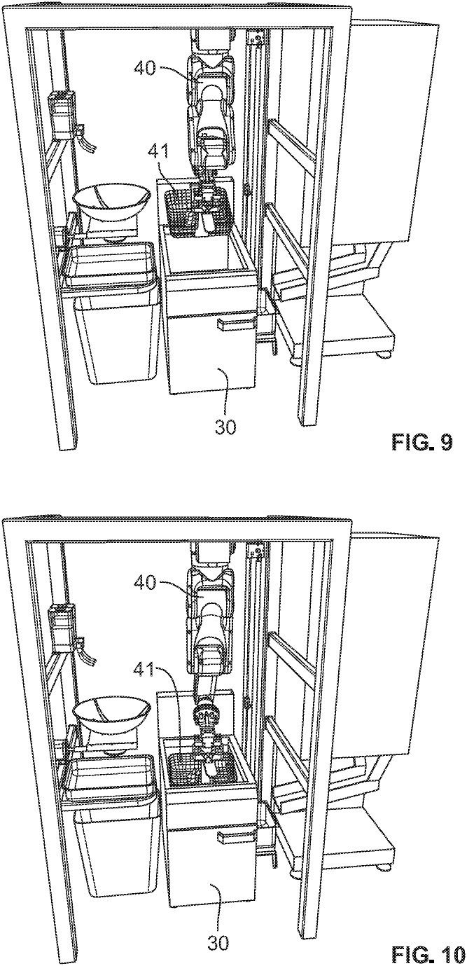

Step 130 states to transfer to fry basket. With reference to FIGS. 7-9, the basin 26 is lifted along linear actuator 32 until it is higher than the fry basket 41 at which point the basin is caused to rotate, thereby dumping the food into the fry basket 41. More specifically, and as shown in FIGS. 8-9, the basin 26 is rotatably coupled to linear carriage 34 by a mount 38. The mount is adapted to freely rotate about an axis perpendicular to the linear actuator 32. The mount 38 includes a guide or slot 39 which is positioned relative to the linear actuator to engage fixed pin 47 as the basin is raised to a target elevation above the fry basket 41.

As the basin 26 is raised above the fry basket 41, the fixed pin 47 is received by basin guide 39, causing the basin mount 38 (and consequently the basin) to rotate as the guide tracks the pin. The slot 39 is designed to cause greater than 90-degree rotation of the basin from upright in order to dump the chips by gravity.

Additionally, in embodiments of the invention, the basin connector 36 or the basin hold 38 includes a magnet or other means to releasably bind the basin connector to the basin hold such that the basin does not fall or slip off the basin connector 36 shown in FIG. 8 when the basin 26 is fully rotated for dumping. The strength of the magnet (or other holding means) should be sufficient to hold the components together during rotation but not so strong to prohibit the components from separating during the weighing step, described above.

Step 140 of the method states frying and agitating. This step can be performed as shown in FIGS. 9-11 in which robotic arm 40 lowers the fry basket 41 of chips into the fryer 30. The robotic arm can be programmed to lower, shake, and raise the fry basket based on time, or optionally, camera or sensor feedback. Exemplary feedback information includes, without limitation, predicted food temperature or vision or IR-based recognition for food separation, doneness or cooking evenness. An example of a robotic kitchen arm for manipulating the fry basket is shown and described in U.S. Pat. No. 11,192,258, filed Aug. 7, 2019, and entitled “ROBOTIC KITCHEN ASSISTANT FOR FRYING INCLUDING AGITATOR ASSEMBLY FOR SHAKING UTENSIL”, incorporated herein by reference in its entirety for all purposes.

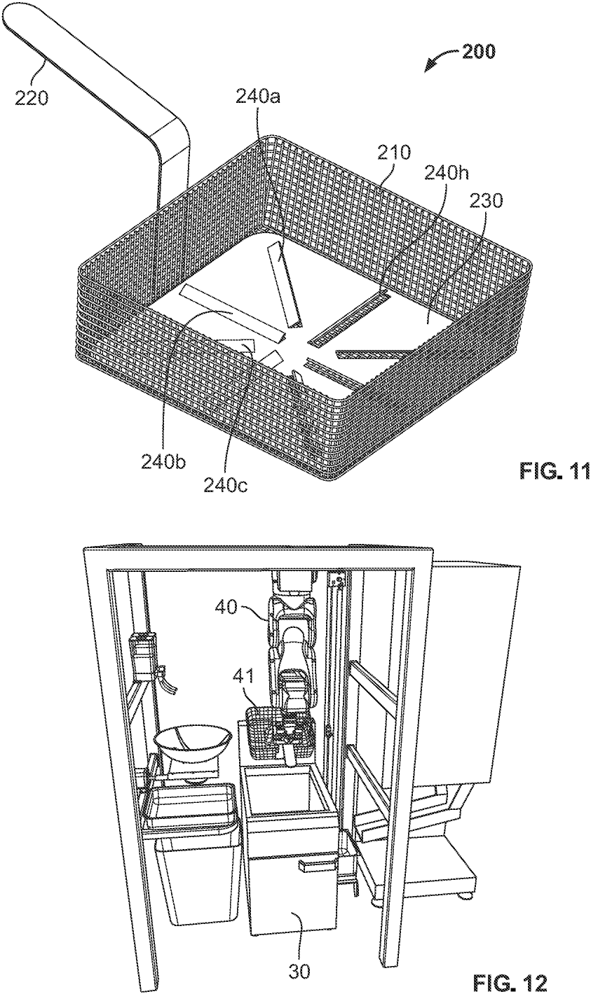

Optionally, and with reference to FIG. 11, a fry basket 200 is operable to passively or self-agitate the food items during frying in accordance with an embodiment of the invention. In the embodiment shown in FIG. 11, the fry basket 200 includes a wire frame 210 and handle grip 220 extending therefrom. A plate 230 includes elongate vents 240a, 240b, 240c ... 240h arranged in a symmetrical pattern radially extending from the center of the plate. Each vent or slot is shown having a flow vane directing the oil or air bubbles at an angle from the plate. In the embodiment shown in FIG. 11, the angle of flow is about 45 degrees, however, the invention is not so limited, and the vanes may direct the flow at other angles, preferably less than 60 degrees and more preferably between 30-60 degrees from the plate. Additionally, the shape, number, and arrangement of the slots may vary greatly. In embodiments of the invention, the plate includes a pattern, slot shape, and number to create vortexes that agitate the food items when frying in oil. Particularly, the hot oil and bubbles and food items are directed by the vanes to move about the basket in a generally circular or spiral flow pattern (e.g., clockwise or counter-clockwise when viewed from the top).

Next, with reference again to FIG. 2 and FIG. 12, step 150 states draining. This step may be performed by the robotic arm 40 lifting the fry basket 41 out of the fryer 30, and allowing the contents to gravity drain and dry above the fryer. Optionally, the robotic arm can be programmed to shake the chips. Optionally, computer vision can be used to observe for doneness, separation, or quality of the food items.

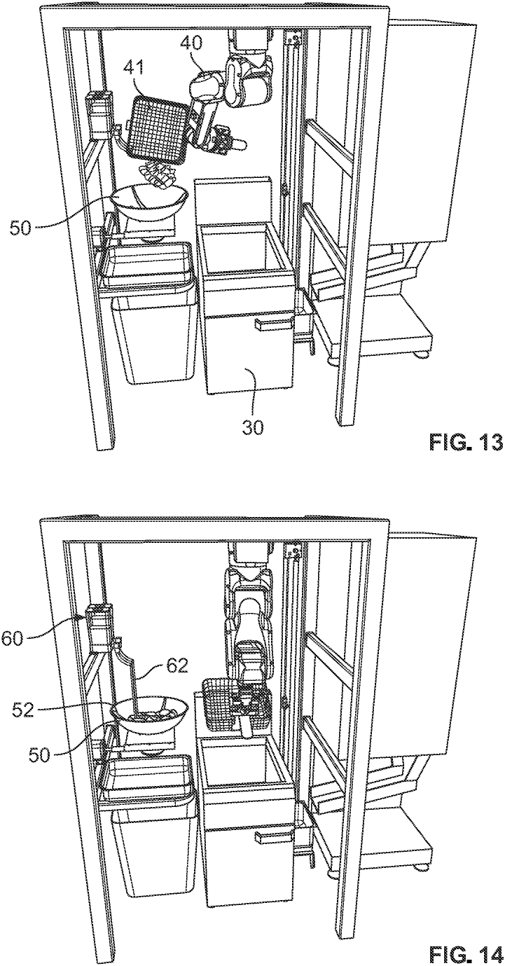

Step 160 states to transfer or dump the cooked food items into the mixing bowl 50. This step may be performed by the robotic arm 40 manipulating the fry basket 41 as shown in FIG. 13 to dump the contents from the fry basket into the mixing bowl. The mixing bowl is shown arranged adjacent the fryer and within reach of the robotic arm.

Step 162 states to dispense the lime and salt. In embodiments of the invention, and with reference to FIG. 14, seasonings 62 such as lime and salt are dispensed by dry and wet dispensers 60 into the mixing bowl 50. Wet seasonings may be controlled using, for example, a liquid pump such as a peristaltic pump. Dry seasoning may be controlled using, e.g., a rotating auger. Indeed, a wide variety of types of seasonings may be arranged above or in the vicinity of the mixing bowl and computer controlled to dispense precise amounts according to predetermined recipes. Examples of seasonings include, without limitation, wet seasonings or sauces of varying viscosities as well dry seasonings or rubs. Examples of wet sauces include hot sauce, BBQ sauce, teriyaki sauce, Mongolian sauce, kung pa sauce, orange chicken sauce.

### Mixing

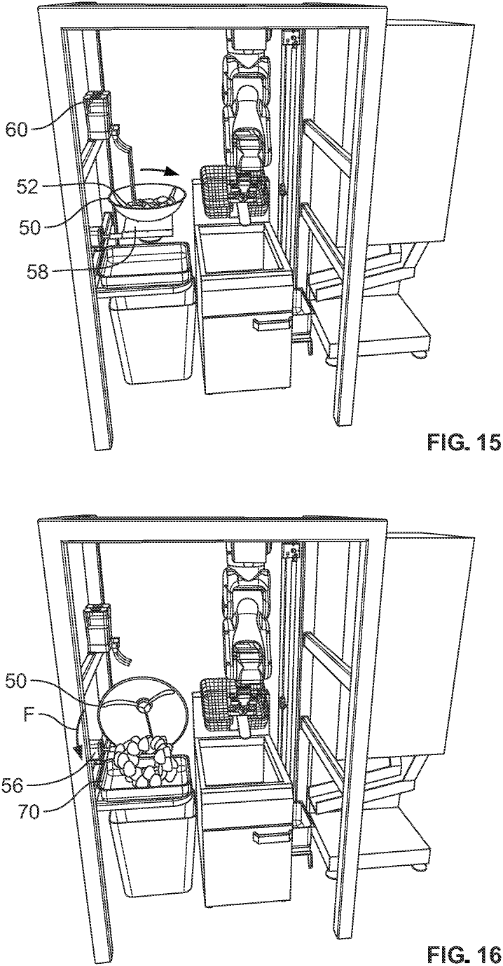

Step 170 states to mix the seasonings in the bowl with the chips. In a preferred embodiment, and with reference to FIG. 15, this step is performed using fixed bowl 50 and rotatable blades 52. The blades 52 are operable to rotate, e.g., clockwise, within the bowl stirring the contents. The first end of each blade is attached to a shaft extending through the center of the bowl. The shaft and consequently the blades are rotatable via a motor (not shown) coupled to the shaft.

Alternatively, the bowl 54 may include fixed ridges and the whole bowl is rotated thereby causing the contents to be stirred together.

The mixing step may be controlled based on preset time. Optionally, computer vision can be used to observe the degree of coverage and mixing. The mixing step can be programmed to be repeated until the contents are deemed to be sufficiently mixed based on computer vision model trained using examples of chips having proper seasoning distribution.

Step 180 states to dump the chips into the receiving pan. With reference to FIG. 16, mixing bowl 50 is arranged on a flat platform 58. The platform 58 is mounted coupled to a shaft, which is rotatable by actuator/motor 56. In operation, the bowl 50 and platform 58 are tilted forward (F) until the chips are ejected into receiving pan 70.

### Cleaning

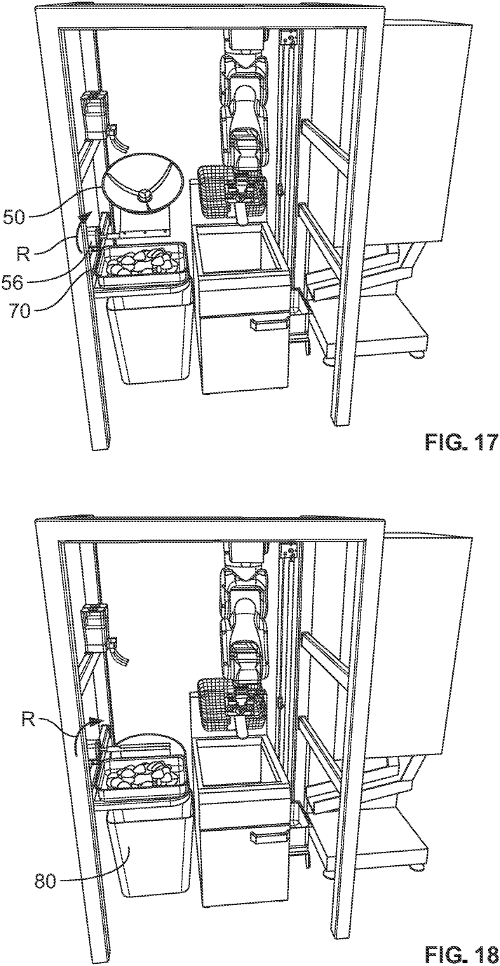

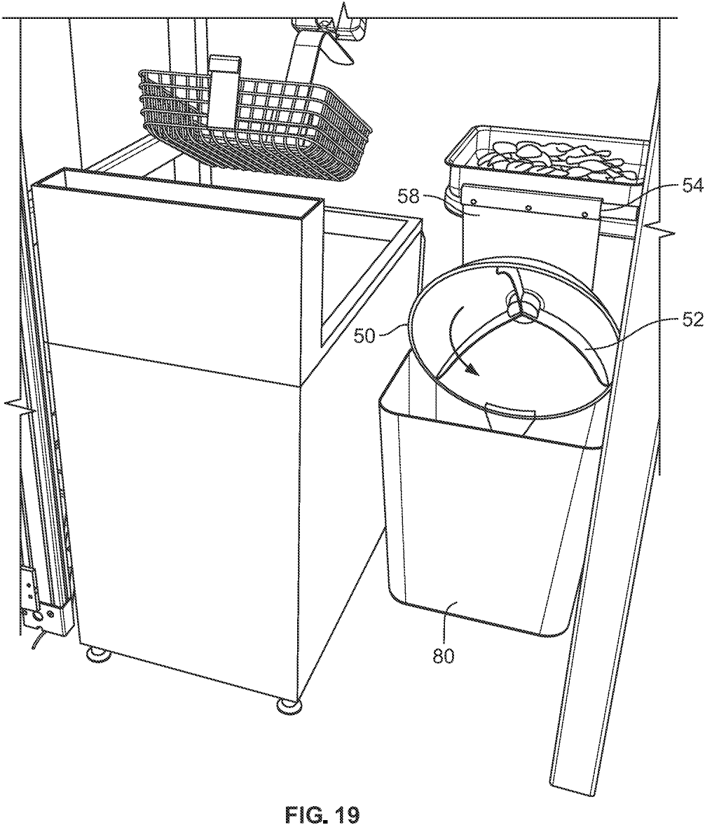

Step 190 states mixing bowl cleaning cycle. With reference to FIGS. 17-19, this step is performed by pivoting the bowl in the opposite direction to that described in step 180, namely, pivoting the platform 58 and bowl 50 rearwardly (R) about axis 54 until the bowl is positioned just above the waste container 80 as shown in FIG. 19. The residue or leftover food and seasonings are shown draining into waste container 80. Additionally, the blades 52 can be rotated to facilitate wiping the bowl clean from residue. In a preferred embodiment, the blades are slightly angled to the surface of the bowl (i.e., not perpendicular) and comprise a soft flexible edge to make contact with the surface of the bowl. Thus, when the blade is rotated the soft flexible edge of the blade forms a squeegee-like interface to wipe the bowl surface clean.

Optionally, one or more spray jets can be arranged to aim air or liquid at the bowl during wiping. In this implementation, the bowl can be quickly rinsed and wiped down after each cook cycle. However, the bowl may also be conveniently removed for cleaning by unscrewing or otherwise detaching the blades and removing bowl from the platform 58.

Also, in embodiments of the invention, the blades are rotated in a first direction for wiping, and rotated in a second direction (opposite to the first direction) during the mixing step. As stated above, the wiping step preferably includes a close fit between a flexible edge of the blade and the bowl surface whereas the mixing step is preferably designed only to stir the contents. The angle of the blades can be set to optimize wiping the bowl during cleaning and in embodiments of the invention, the blades are arranged with the bowl surface to form an acute angle for wiping and, consequently, an obtuse angle for mixing.

### Hardware Block Diagram

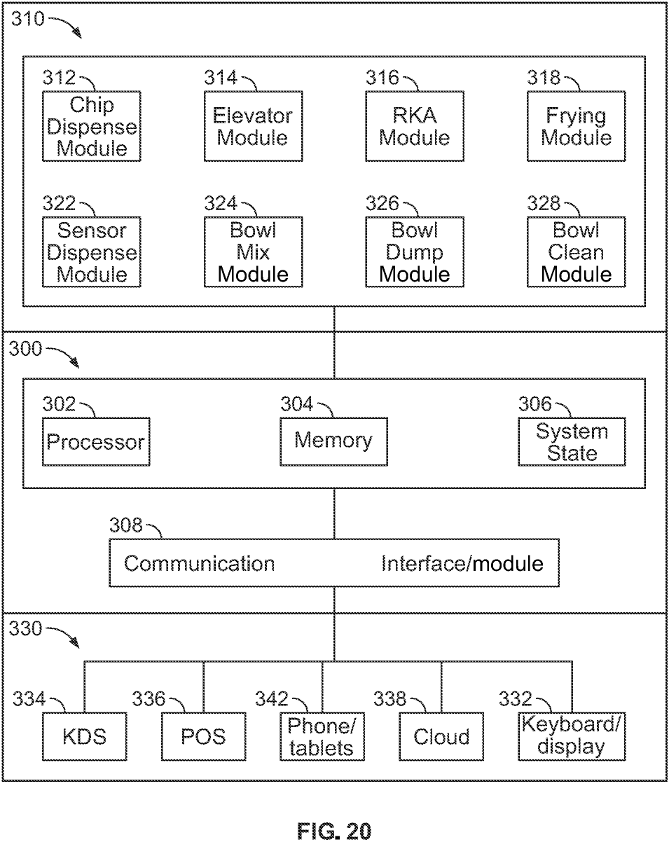

With reference to FIG. 20, a block diagram of a food fryer system includes a computer and electronics 300, a plurality or hub of functional modules 310, and one or more input devices 330.

Examples of functional modules 310 include: chip dispense module 312, elevator module 314, robotic arm module 316, fryer module 318, season dispense module 322, bowl mix module 324, bowl dump module 326, and bowl clean module 328. Each module is shown in communication with the computing system 300. In embodiments of the invention, each module includes its own hardware and electronics including, e.g., a dedicated controller, processor, memory, PCB, integrated chip, and one or more sensors. Optionally, one or more of the modules are self-contained functional units that are conveniently coupled to the computing system 300. For example, in embodiments of the invention, the refrigerated hopper/dispenser 20 and fryer 30 are self-contained units that are conveniently arranged with the frame 40, and connected electronically to the computer 300 to control the method steps as described above.

The computing device 300 can be a conventional micro-computer and the like including, for example, one or more processors 302, memory or storage devices 304, system state module 306 for keeping track of all events, status, and steps occurring during operation, and communication interface 308. However, the computing device may vary widely and include additional processors, types of memory, ports, communication interfaces (e.g., Wi-Fi, Bluetooth, ethernet, etc.), power supplies, and other components. The computing device 300 can be internal to or remote from the fryer system. The computing device 300 can be responsive to instructions or requests from a number of input devices 330. Examples of input devices include, without limitation, POS systems 336, tablets and smart phone 342, kitchen display systems (KDS) 334, and onboard touch screens or displays 332. Instructions or requests can be entered by an operator, team member, customer, or another as the case may be.

FIG. 20 also shows server 338 which can be remote or cloud-based. Such remote servers 338 can be used to generally communicate with the system, receive and store data, upload program updates, and host an associated a website. Local input devices (e.g., without limitation, tablets, smart phones, desktop or workstations) may download a program or App to conveniently communicate with the website to place an order and monitor activity.

Additionally, a wide variety of sensors can be incorporated with or otherwise used with each of the modules.

For example, a limit switch can sense when the elevator basin is at a home position. The system can be programmed to prohibit the chip hopper from dispensing chips when the limit switch is not in the home position. An example of a suitable limit switch is model XVM3SBQF1802L03, manufactured by CIT Relay and Switch (Rogers, MN).

Photo-presence sensors can be used to monitor for whether an object is present. For example, should the fry basket not be detected, the method proceeds to stop operation until it is replaced. An example of a suitable photo-presence sensor is model WL15-A2430, manufactured by SICK AG, (Waldkirch, Germany).

Load sensors can be used to detect weight. Based on the detected weight, the system can compute whether the proper amount of chips have been dispensed into the elevator basin. An example of a suitable load cell is model LCEB, manufactured by Omega Engineering Inc. (Norwalk, CT).

Break beam sensors/reflectors can monitor for a break in the beam. For example, the break beam sensor can monitor if the mixing bowl is in the home position. An example of a suitable break beam sensor and reflector is model O6S202 – O6S-OOKG/AS/3P, manufactured by ifm Efector, Inc. (Malvern, PA 19355).

Proximity sensor(s) can monitor for position of the components. For example, one or more proximity sensors may be used to detect the position of the elevator. An example of a suitable proximity sensor is model DW-AD-504-M5, manufactured by Contrinex Gmbh. (Corminboeuf, Switzerland).

In embodiments of the invention, cameras are added and aimed at one or more of the stations. The camera images are sent to the computer processors for determining food item recognition, localization, tracking, food aggregation/clumping, food doneness, and seasoning uniformity. Computer modules for use with the cameras and sensors are described in U.S. Provisional Application No. 63/196,636, filed Jun. 3, 2021, entitled “AUTOMATED KITCHEN SYSTEM FOR ASSISTING HUMAN WORKER PREPARE FOOD”; U.S. Pat. Publication No. 20210022559, filed Jul. 25, 2020, entitled “TRANSPORTABLE ROBOTIC-AUTOMATED KITCHEN WORKCELL”, and U.S. Pat. No. 10,919,144, filed Aug. 10, 2018, entitled “MULTI-SENSOR ARRAY INCLUDING AN IR CAMERA AS PART OF AN AUTOMATED KITCHEN ASSISTANT SYSTEM FOR RECOGNIZING AND PREPARING FOOD AND RELATED METHODS”, each of which is incorporated herein by reference in its entirety.

### Alternative Embodiments

The invention is intended to include a wide variety of embodiments.

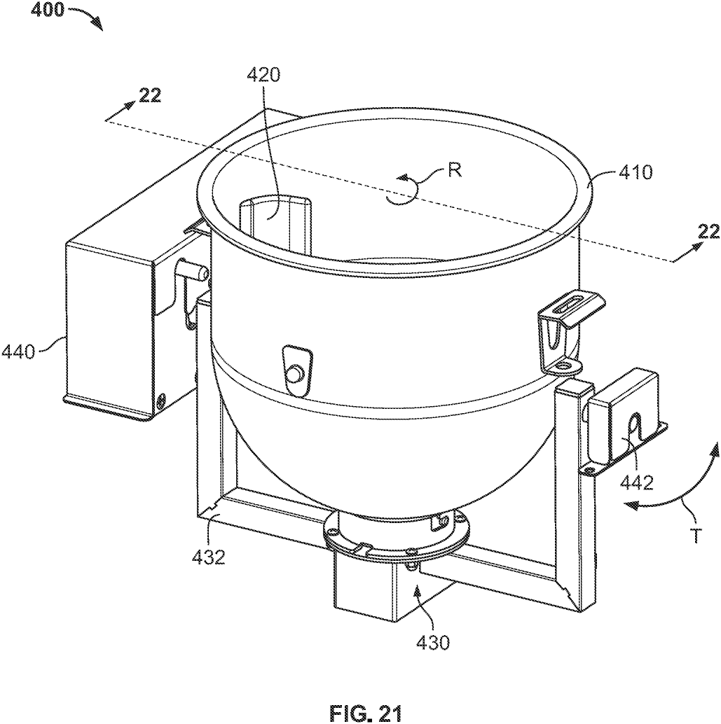

For example, with reference to FIGS. 21-25, another mixing bowl assembly 400 is shown in accordance with embodiments of the invention. The assembly 400 includes a bowl 410 and an elongate blade-like member 420 arranged to scrape the interior surface of the bowl to mix the contents therein. The bowl 410 and blade motor 430 are fixed to frame 432. The entire assembly is tiltably (T) hung between supports 440, 442. As described above, after the contents are mixed, they are dumped into serving pan. Then, the bowl may be tilted in the opposite direction to drain any residue from the bowl. Optionally, the interior may be sprayed or rinsed before returning to its ‘home’ position for receiving the next batch of food.

Additionally, although only one blade is shown in FIG. 21, in other embodiments of the invention, the bowl assembly may include a plurality of blades.

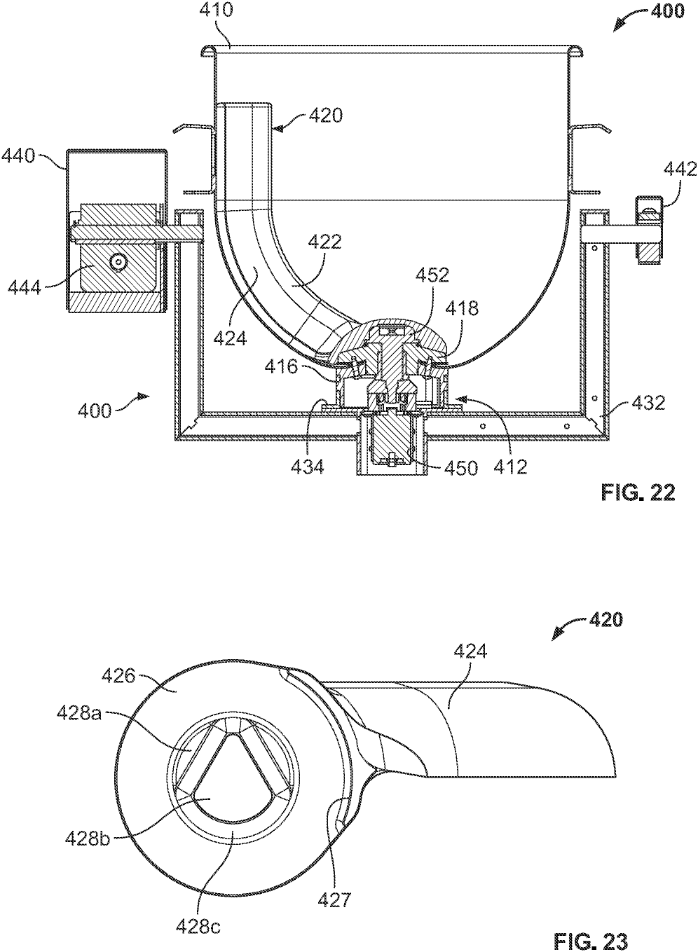

FIG. 22 is a cross sectional view of the bowl assembly 400 taken along line 22-22. Support 440 is shown holding a motor 444 operable to rotate a first shaft that is connected to the frame 432. Opposite support 442 is shown rotatably holding a second shaft which is also connected to frame 432. As stated herein, the entire bowl assembly can be tilted forward and rearward about the first and second shaft when the motor 444 is actuated.

FIG. 22 also shows the blade 420 extending upwards from a rounded base. The blade profile gentle curves from 0 degrees to 90 degrees, and preferably matches the curvature of the bowl 410. Blade 420 is shown having an arcuate (L or U) cross sectional shape formed by a pair of walls 422, 424 extending upwards from the base. One wall 424 runs generally parallel to the interior surface of the bowl, and the second wall 422 extends towards the center axis of the bowl. As described above, the wall 422 closest the bowl may be arranged at an angle and flexibility to (a) lift the chips and ingredients from the wall surface during mixing blade motion and (2) skim the wall surface serving to squeegee the bowl surface during the cleaning blade motion.

The blade 420 is rotated by a motor 450 via a hub assembly 412 that is removably engaged to a receptable (collectively shown by reference numerals 428a, b, c in FIG. 23) in the bottom of the blade, discussed below. Hub assembly 412 comprises a lower hub 416, upper flange 418 fastened to the lower hub clamping the base of the bowl therebetween, and a rotatable shaft or coupler 452.

FIG. 22 also shows collar bracket 434 attached to frame 432. The collar bracket 432 is adapted to detachable receive the lower hub 416 of the hub assembly. Optionally, the collar bracket 434 and lower hub 416 have a slot-pin type engagement such that the lower hub (bowl and components attached thereto) may be removed from the bracket 434 (and consequently frame 432) as a one-piece assembly by simply rotating (and then lifting) the bowl from the bracket collar 434.

FIG. 23 shows an enlarged bottom view of the blade 420 including an arm 424 extending from a base 426. With additional reference to FIGS. 22 and 25, base 426 is adapted to fit over the upper flange 418 and coupler 452. In the embodiments shown in FIG. 23, base includes a lip 427 serving to prohibit food from flowing beneath the blade as the blade is rotated. Blade 420 additionally shows keyed receptacle (collectively formed with reference to features 428a, 428b, 428c) to interlock or register with the coupler 452. In this embodiment, the receptable has a triangular opening 428b, transition regions 428c, and circular base region 428a. The features are operable together to register with the coupler 452, such that when the coupler is rotated, the blade rotates.

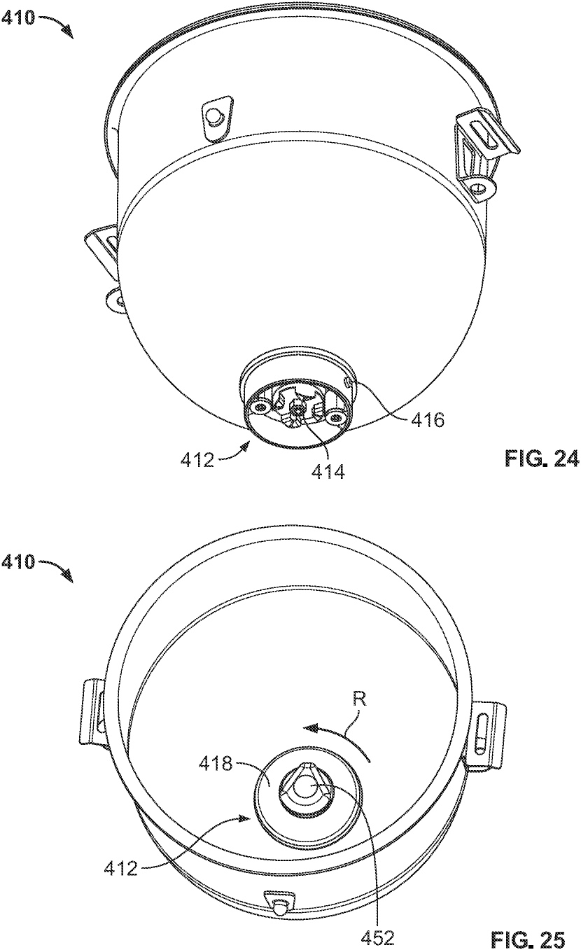

FIG. 24 shows the bowl and lower hub assembly as a one-piece assembly. FIG. 24 also shows the lower surface 414 of the rotating coupler 452 including four teeth which can be engaged to a matching gear connected to the motor 450.

FIG. 25 is a top view of the bowl assembly showing hub assembly 412 including the upper flange 418, and coupler 452 with the blade removed for clarity.

### End Effector Assembly

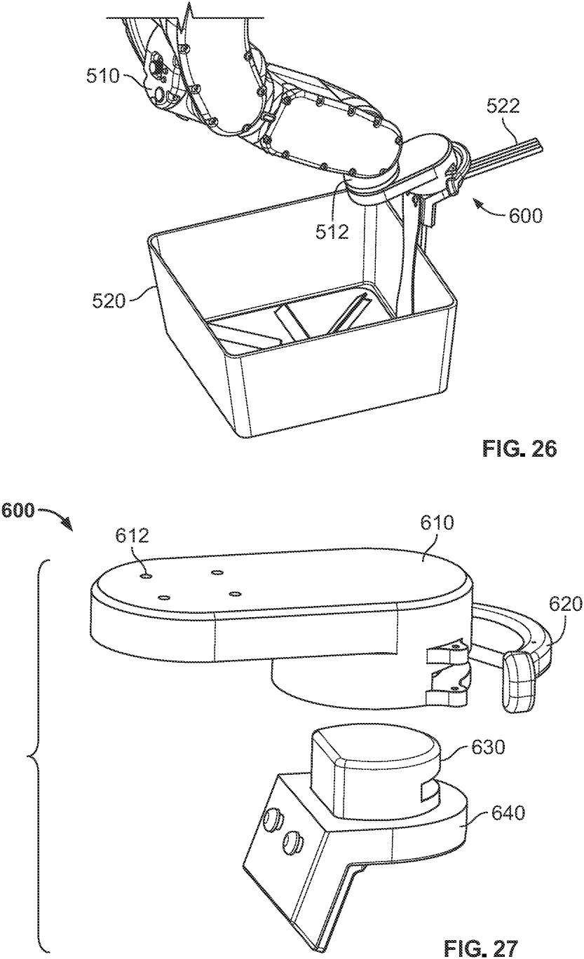

FIG. 26 illustrates a partial view of a robotic arm 510 holding a fry basket 520 in accordance with another embodiment of the invention. In particular, FIG. 26 shows robotic arm end effector 512 attached to a clamp assembly 600 which can removably engage a handle portion of the fry basket 520, discussed herein.

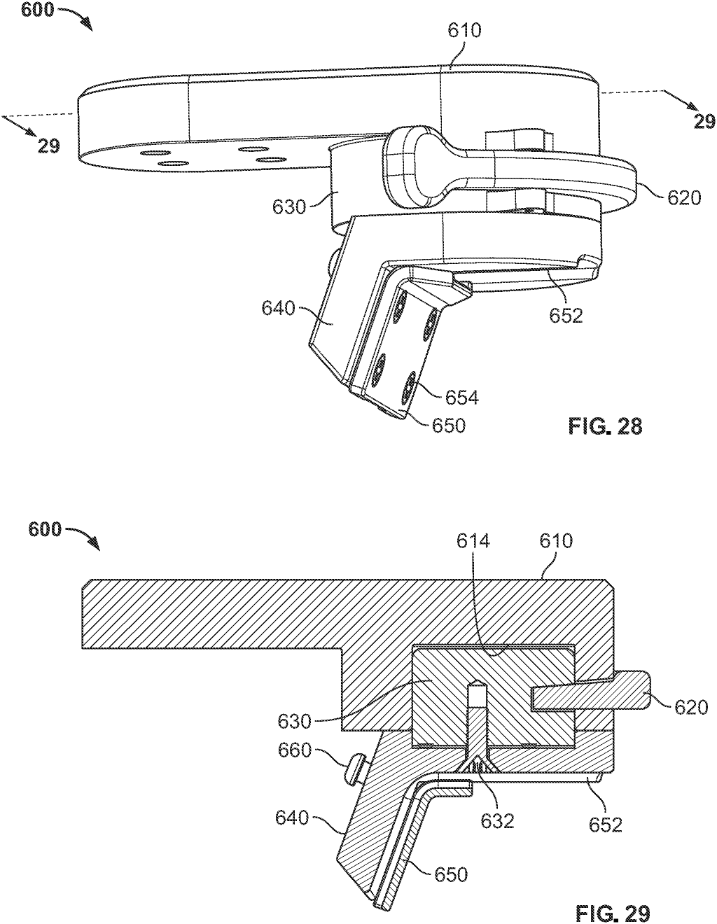

With reference to FIGS. 27-29, operation of the clamp assembly 600 is illustrated in sequence from an open/unlocked configuration (FIG. 27) to a closed/locked configuration (FIGS. 28, 29). In particular, a socket 610 includes fastener holes 612 for mounting the socket to the end effector 512. The socket 610 also includes a cavity 614 adapted to receive a plug 630 extending from the handle portion 640. The plug is shown having an oblong or semispherical profile. The plug is also shown fastened to handle portion via, e.g., screws 632.

After the plug 630 of the handle portion 640 is inserted into the cavity 614 of the socket 610, wedge 620 is advanced into the cutout in the plug. As the wedge is further advanced, the plug is urged upwards until it is locked therein. Preferably the wedge member 620 is arranged on the socket 610 by a pin or hinge to pivot from an open configuration as shown in FIG. 27, to a closed/locked configuration as shown in FIGS. 28, 29.

### Fryer Basket Attachment

In embodiments of the invention, the fry basket 520 can be affixed to the clamping assembly 600 using fasteners. More preferably, however, the fry basket 520 is removably attached to the handle portion 640 using keyhole slots and step pins. With reference to FIG. 29, for example, step pins 660 are shown extending from handle portion. The keyhole slots in the basket may be aligned over the pins and manipulated downwards to lock the basket to the handle portion as shown in FIG. 26.

In embodiments of the invention, the handle portion 640 may be extended. The handle portion 640 shown in FIG. 28, for example, includes a cutout or channel 652 which extends lengthwise for the length of the handle 640. A plate 650 can be fastened over the channel 652 to attach an extension member (e.g., 522 of FIG. 26) to the clamping assembly. The extension member can extend the handle 640, allowing a worker to conveniently grip and manipulate the fry basket.

Additionally, if use of a conventional fry basket is desired (e.g., fry basket 41 shown in FIGS. 1,3) that has a pre-integrated long handle, the channel/plate (652/650) arrangement described above can accommodate it. The channel 652 is arranged over the pre-existing handle. The plate 650 is secured to portion 640, locking the pre-existing handle to the clamping assembly 600.

Indeed, there are many arrangements to couple a fry basket, handle and robotic arm to one another, all of which are intended to be included in the present invention except where specifically excluded in any appended claims.

Still other modifications and variations can be made to the disclosed embodiments without departing from the subject invention. For example, additional functional buttons, GUIs, functional stations, and other components can be included in an automated fryer system. Additionally, in embodiments of the invention, the automated fryer system may have less functional stations and components than that shown and described herein.

1. An automated food frying system comprising:
a plurality of functional stations selected from the group comprising:
a dispensing station for dispensing a predetermined amount of raw food;
a food transfer station for transferring the raw food to a fry basket;
a fry station for frying the raw food into cooked food;
a mixing station for mixing the cooked food with at least one type of seasoning; and
a computer system programmed to control the plurality of functional stations, in sequence, to dispense the raw food, transfer the raw food to the fry basket, fry the raw food, transfer the cooked food to the mixing station, and mix the cooked food with at least one seasoning.

2. The system of claim 1, wherein the food transfer station comprises a basin, and an elevator to raise the basin from a home elevation lower than the fry basket to a target elevation higher than the fry basket.

3. The system of claim 2, wherein the elevator comprises a linear actuator and a carriage assembly that is operable to move up and down along the linear actuator, and to tilt the basin when the basin reaches the target elevation.

4. The system of claim 3, wherein the carriage assembly includes a carriage that moves along the linear actuator and a basin mount rotatably coupling the basin to the carriage such that the basin is free to rotate about an axis perpendicular to the linear actuator.

5. The system of claim 4, wherein the mount comprises a guide which is positioned relative to the linear actuator to engage a fixed pin as the basin is raised above the fry basket, and such that when the basin is being raised above the fry basket, the fixed pin is received by the basin guide, causing the basin mount (and consequently the basin) to rotate as the guide tracks the pin.

6. The system of claim 5, wherein the slot and guide are arranged to cause a greater than 90-degree rotation of the basin from upright in order to dump the cooked food.

7. The system of claim 6, further comprising a magnet interface between the mount and the carriage to prevent the basin from separating from the carriage when the basin is rotated to dump the cooked food.

8. The system of claim 2, wherein the dispensing station includes a cold storage, a hopper, and a ramp to direct the food into the elevator basin when the basin is positioned at the home elevation.

9. The system of claim 1, further comprising the fry basket, and wherein the fry basket comprises side walls and a bottom plate, and wherein the bottom plate includes a plurality of vents arranged along the bottom to direct the oil and food through the basket, thereby reducing clumping of the food in the basket during cooking.

10. (canceled)

11. (canceled)

12. (canceled)

13. The system of claim 1, further comprising a robotic arm for transferring the cooked food from the fry station to the mixing station, and a clamp assembly mounted to the robotic arm via an end effector, wherein the clamp assembly is adapted to detachably hold the fry basket.

14. The system of claim 13, wherein the clamp assembly comprises a plug and a socket adapted to receive the plug.

15. The system of claim 14, wherein the plug comprises a lateral cut out, and the socket comprises a lateral window that aligns with the cutout when the socket is inserted into the socket.

16. The system of claim 15, wherein the clamp assembly further comprises a locking member to hold the socket to the plug through the window and cutout.

17. The system of claim 16, wherein the locking member has a wedge shape such that as the locking member is advanced into the cutout, the plug is further advanced into the socket.

18. The system of claim 17, wherein the socket is attached to the end effector, and the plug is attached to the fry basket.

19. The system of claim 1, wherein the mixing station comprises a bowl assembly, and wherein the bowl assembly comprises a bowl and a blade rotatable within the bowl.

20. The system of claim 19, further comprising at least one ingredient dispenser operable to dispense the at least one ingredient into the bowl.

21. The system of claim 20, wherein the bowl assembly is detachably coupled to a frame that is tiltably hung between opposing supports.

22. The system of claim 21, wherein the mixing station further includes a motor mounted to the frame.

23. The system of claim 22, wherein the bowl assembly further comprises a hub assembly that is removably engageable with the motor mounted on the frame.

24. The system of claim 23, wherein the computer is programmed and operable to tilt the bowl assembly forward to a dispense position, wherein the dispense position is at a first angle such that at least a portion of the food falls from the bowl into a receiving area.

25. The system of claim 24, wherein the computer is programmed and operable to tilt the bowl assembly to a clean position, wherein the clean position is at a second angle such that residue falls from the bowl into a debris collection area.

26. The system of claim 25, wherein the computer is programmed and operable to rotate the blade when the bowl is in the clean position.

27. The system of claim 25, further comprising a sprayer aimed at the bowl when the bowl is in the clean position, and the computer is programmed and operable to cause the sprayer to rinse the bowl during cleaning.

28. The system of claim 1, wherein the computer is programmed and operable store and update status of the food, wherein the status comprises at least one status from the groups comprising: on-line/ready, dispensing, frying, mixing, order ready/pickup, service, off-line.

29. The system of claim 28, wherein the computer is programmed and operable to receive orders, make modifications to the order, and provide reports including the order, status, and time.

30. The system of claim 1, further comprising a weighing station comprising a scale for weighing the raw food from the food dispensing station, and wherein the food transfer station is operable to lower the basin onto the scale to weigh the raw food.

31. The system of claim 30, wherein the computer is programmed and operable control the food transfer station and food dispensing station to add more raw food to the basin if an order or recipe calls for more raw food than was initially dispensed into the basin.

32. The system of claim 2, further comprising at least one sensor to detect the presence of the basin along the linear actuator, and wherein the computer system and the at least one sensor are operable monitor the elevation of the basin.

33. A method for automatically frying food comprising the following steps:
dispensing a predetermined amount of food into a basin;
transferring the raw food from the basin to a fry basket;
frying the raw food into cooked food;
robotically transferring the cooked food from the fry basket to a mixing bowl; and
dispensing at least one type of seasoning into the bowl;
mixing the cooked food with the at least one type of seasoning; and
dumping the cooked food mixed with the at least one seasoning into a receiving pan; and
wherein each of the steps is controlled by a computer system.

34-43. (canceled)
